(19) United States
(12) Patent Application Publication
(10) Pub. No.: US 2007/0068010 A1
(43) Pub. Date: Mar. 29, 2007

(54) Cutting blade

(75) Inventor: Yasuhiro Annoura, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/525,914

(22) Filed: Sep. 25, 2006

(30) Foreign Application Priority Data
Sep. 26, 2005 (JP) 2005-278836

(51) Int. Cl. B26B 9/00

(52) U.S. Cl. 30/350

(57) ABSTRACT

A cutting blade is used for press-cutting a stack of layered sheets and has an edge portion formed of a high-speed steel powder sintered body.

### CROSS-REFERENCE TO RELATED APPLICATION

This application claims priority under 35 USC 119 from Japanese Patent Application No. 2005-278836, the disclosure of which is incorporated by reference herein.

### BACKGROUND OF THE INVENTION

1. Field of the Invention

The present invention relates to a cutting blade and in particular to a cutting blade that will not form burrs on sheet edges even after cutting a large number of sheets.

2. Description of the Related Art

In recent years, a laser exposure type planographic printing plate that is exposed by a laser beam has become widely used.

A printing image is directly recorded on a laser exposure type planographic printing plate by laser beam. Accordingly, a difference in distance between a planographic printing plate that is to be exposed and a laser source applying laser beam to the planographic printing plate causes a significant change in sensitivity. Therefore, for a laser exposure type planographic printing plate, floating should be kept smaller during exposure than for a conventional photosensitive type planographic printing plate.

Protrusion in a direction of thickness called “warp” which is formed when cutting planographic printing plates is regarded as one major cause of floating.

In a conventional photosensitive type planographic printing plate, the allowance of warp is, for example, approximately 200 μm. On the other hand, in a laser exposure type planographic printing plate, the allowance of warp made be reduced to 50 μm or less.

To reduce warp, it is thought to be recommendable that the edge of a cutting blade be sharply finished and that the edge be kept sharp even after cutting a large number of planographic printing plates. Thus, a material having a high degree of hardness can be recommended to be used for the edge.

A cutting blade having a cutting metal formed of die steel powder and brazed at a stepwise portion formed on a base metal is proposed in Japanese Patent Application Laid-Open (JP-A) No. 11-300688.

However, a conventional material having a high degree of hardness entails reduced toughness and thus, is often brittle. Hence, when a material having a high degree of hardness is used to form an edge of a cutting blade or when the surface of an edge of a cutting blade is hardened, the edge is prone to be nicked.

A material having a high degree of hardness often has high chromium content and chromium is easily fusion-bonded to a metal such as aluminum, which is widely used as a support body for a planographic printing plate.

Consequently, when cutting a stack of planographic printing plates by a cutting blade having an edge formed of a material having a high degree of hardness, aluminum adhering to the edge of the cutting blade makes scratches on a cut surface of the stack.

### SUMMARY OF THE INVENTION

A first aspect of the present invention provides a cutting blade used for press-cutting a stack of layered sheets comprising an edge portion formed of a high-speed steel powder sintered body.

### BRIEF DESCRIPTION OF THE DRAWINGS

FIG. 1 is a front view showing a state where a stack of planographic printing plates is cut by a cutting blade of an embodiment 1;

FIG. 2 is a cross-sectional view of the cutting blade of the embodiment 1;

FIG. 3 is a cross-sectional view showing a state where cutting a stack of planographic printing plates by the cutting blade of the embodiment 1 is started;

FIG. 4 is a cross-sectional view showing a state where cutting the stack of planographic printing plates by the cutting blade of the embodiment 1 is finished;

FIG. 5 is a graph showing the relationship of the cutting number of a stack of planographic printing plates cut by the cutting blade of the embodiment 1 to a burr on the topside, to a burr on the backside, and to a warp;

FIG. 6 is an explanatory diagram showing a burr on the topside, a burr on the backside, and a warp formed by cutting a planographic printing plate; and

FIG. 7 is a graph showing a relationship between the cutting number of stacks of planographic printing plates by the cutting blade of the embodiment 1 and the size of warp.

### DETAILED DESCRIPTION OF THE PREFERRED EMBODIMENTS

### 1. Embodiment 1

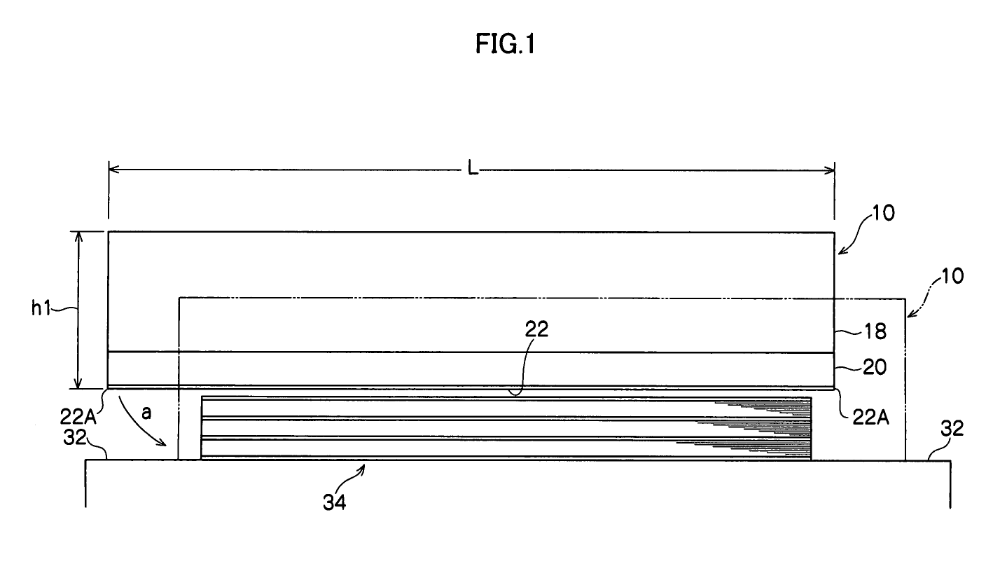

As shown in FIG. 1 to FIG. 3, a cutting blade 10 of an embodiment 1 has a length(L) of 2190 mm, a height(h1) of 149 mm, and a thickness(t1) of 12 mm, and is mounted in a cutting device (not shown, Senator Type185 guillotine made by Schneider AG.). The cutting blade 10 is swung to descend to cut planographic printing plates 12, slip sheets 14, and cardboards 16, which are alternately stacked.

Swinging means a motion of the cutting blade 10 descending with the left support thereof held slightly lower than the right support thereof while the edge thereof moves in an arc. The positions of the left support and the right supports are adjusted to change the path of the cutting blade 10 in accordance with the property of an object that is cut by the cutting blade 10 so as to obtain a good quality of the cut surface of the object.

The base metal 18 of the cutting blade 10 is made of carbon steel for machine structural use S45C/S55C (JISG4051) or rolled steel for general structural use SS400 (JISG3101), and the material of an edge portion 20 is a sintered body of high-speed steel powder HAP10 (trade name, produced by Hitachi Metals, Ltd.). The edge portion 20 is brazed to the base metal 18 with a brazing material containing a metal such as silver or copper as a principal ingredient. The material of the edge portion 20 is not limited to HAP10 and any high-speed steel powder sintered body having a chromium content of 8.5 weight % or less can be used as the material. Moreover, the edge portion 20 preferably has a shore hardness (JISZ2246) of from 58 to 70 and a Charpy impact strength of from 3 to 13 (kgf·m/cm²). The edge portion 20 preferably has a transverse rupture strength of from 450 to 600 (kgf/cm²). The edge portion 20 also has a height (h2) of from 20 to 80 mm and a thickness (t2) of from 2 to 6 mm (mainly, 3 mm), but is not limited to the size mentioned above.

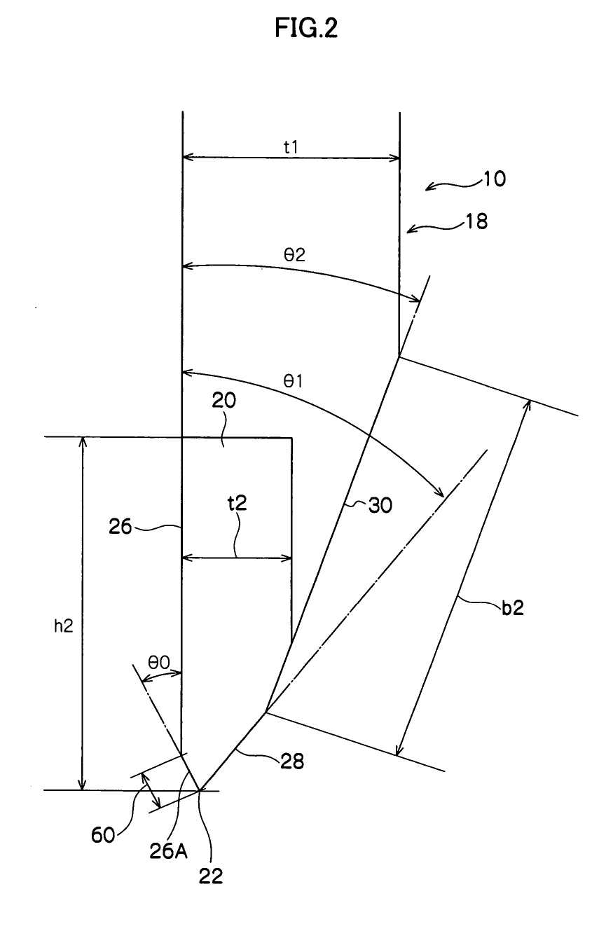

As shown in FIG. 2, a backside edge surface 26A is formed on the edge 22 of the edge portion 20 so as to slightly inclining to a backside surface 26. The backside edge surface 26A can be formed by manually grinding the backside surface of the edge 22 with a grinding stone. The backside edge surface 26A formed on the edge 22 makes the edge portion 20 not prone to nick even just after the edge portion 20 is ground. Since the backside edge surface 26A is formed at the edge 22, the planographic printing plate 12 can be cut even from the beginning and little burr is formed on the corner of the cut surface of the planographic printing surface 12. The inclination angle θ0 to the backside surface 26 (vertical surface sliding on the cut surface of the sheets) of the backside edge surface 26A and the width b0 of the backside edge surface 26A are 2 degrees and 0.01 to 0.05 mm, respectively. The inclination angle θ and the width d0 are preferably 0 to 15 degrees and 0.005 to 1 mm, respectively.

In the edge portion 20, a first edge surface 28 inclining at an inclination angle θ1 with respect to the backside surface 26 on a side opposite to the backside edge surface 26A is formed from the edge 22 on a front surface side. Moreover, a second edge surface 30 inclined at an inclination angle θ2 with respect to the backside surface 26 is formed from the end of the first edge surface 28 in the edge portion 20. In the present embodiment, the first edge surface 28 has an inclination angle θ1 of 31 degrees, a width b1 of 0.5 to 1.0 mm, a surface roughness of 0.3 to 0.5 μm. The second edge surface 30 has an inclination angle θ2 of 28 degrees, and a width b2 of 22 mm. θ1, θ2, b1, and b2 are preferably 29 to 34 degrees, 26 to 30 degrees, 0.3 to 3 mm, and 5 mm or more, respectively.

A carbon film (not shown), which has a Vickers hardness (JISZ2244) of 3000 to 5000, an amorphous structure and a thickness of 0.3 to 3 μm and is commonly known as “diamond-like carbon”(DLC), is deposited on the backside surface 26 of the edge portion 20 by ion plating.

The edge portion 20 is coated with the carbon film to reduce a metallic affinity with the cut surface of the planographic printing plate 12, and thus, adhesion of aluminum to the edge portion 20 can be prevented, in other words, formation of a built-up edge can be prevented. Accordingly, quality of the cut surface is improved and the life of the cutting blade is extended.

A process for cutting a stack of planographic printing plates by using the cutting blade of the present embodiment will be described.

As shown in FIG. 1 to FIG. 4, a stack of planographic printing plates 34 are placed on a rest 32 and are pressed by a clamp 36 applying a force of 4 to 6 tons. The stack of planographic printing plates 34 is pressed and cut by moving down (swinging) the cutting blade 10 obliquely from the top left to the bottom right. Thus, the central portion of the edge 22 is pressed into the stack of planographic printing plates 34 without the corner 22A of the edge 22 hitting the stack of planographic printing plates 34. The cutting blade 10 can move obliquely from the top right to the bottom left.

The planographic printing plate 12 is formed by forming a coating (a photosensitive layer for a photosensitive planographic printing plate, or a thermo-sensitive layer for a thermo-sensitive planographic printing plate) on a roughened surface of an aluminum support, of which roughened surface is formed by subjecting a thin aluminum plate to a mechanical roughening process using a brush, or to a chemical or electrochemical roughening process using acid or alkali and then, subjected to an appropriate combination of anodic oxidation process and silicate process to form a surface film thereon.

The coating is subjected to a plate making process including exposure, development, and gumming and then is set in a printing machine and is coated with ink, and thus, letters and images are printed on paper. The planographic printing plate 12 of the present invention is a printing plate that is yet to be subjected to a process needed for printing such as exposure or development, and is also referred to as an “unexposed planographic printing plate” or a “planographic printing material”. Hereinafter the surface of the planographic printing plate on which the coating is formed will be referred to as an “image forming surface” and the surface thereof on which the coating is not formed will be referred to as a “non-image forming surface”. The planographic printing plate 12 also includes a so-called “double-sided plate” wherein image forming surfaces are formed on both surfaces.

As long as the planographic printing plate 12 is constructed as described above, the specific construction thereof is not limited. For example, a planographic printing plate 12 that is a laser-exposing printing plate of a heat-mode type or a photon-mode type can be made up directly in accordance with digital printing data.

The planographic printing plate 12 includes planographic printing plates corresponding to various plate-making processes having different kinds of components incorporated in a photosensitive layer or a thermo-sensitive layer thereof. Examples of specific embodiments of the planographic printing plate of the present invention include the following embodiments (1) to (11):
(1) an embodiment which the photosensitive layer contains an infrared absorbing agent, a chemical compound generating acid by heat, and a chemical compound forming a cross-link by acid;
(2) an embodiment which the photosensitive layer contains an infrared absorbing agent and a chemical compound that can be made soluble in alkali by heat;
(3) an embodiment which the photosensitive layer includes two layers: a layer containing a chemical compound generating a radical by laser beam irradiation, an alkalinizing binder, and a layer containing a poly-functional monomer or a pre-polymer, and an oxygen insulating layer;
(4) an embodiment which the photosensitive layer includes two layers: a physical developing nucleic layer, and a silver halide emulsion layer;
(5) an embodiment which the photosensitive layer includes three layers: a polymerized layer containing a poly-functional monomer and a poly-functional binder, a layer containing silver halide and a reducing agent, and an oxygen insulating layer;
(6) an embodiment which the photosensitive layer includes two layers: a layer containing a novolac resin and naphthoquinone diazide, and a layer containing silver halide;
(7) an embodiment which the photosensitive layer contains an organic photoconductor;
(8) an embodiment which the photosensitive layer is formed of two or three layers including a laser-absorbing layer removed by laser beam irradiation, a lipophilic layer, and/or a hydrophilic layer;
(9) an embodiment which the photosensitive layer contains an acid generating agent generating an acid by absorbing energy, a high-molecular compound having a functional group generating sulfonic acid or carboxylic acid as the acid, and a chemical compound providing energy to the acid generating agent by absorbing visible light;
(10) an embodiment which the photosensitive layer contains a quinone diazide compound and a novolac compound; and
(11) an embodiment which the photosensitive layer contains a compound decomposed by visible light or ultraviolet ray and forms a cross-linked structure with the same or different kind of molecules in the layer, and an alkali soluble binder.

A stack of planographic printing plates 34 generally has the following construction: 10 to 200 sheets of planographic printing plates 12 and slip sheets 14 are stacked alternatingly; and cardboards 16 are placed on both surfaces of the stacked planographic printing plates 12 and slip sheets 14. The example shown in FIG. 1 to FIG. 3 shows three stacks of planographic printing plates 34 stacked up, but the number of stacks is not limited to three. The planographic printing plates 12 is a planographic printing plate made of an aluminum plate having a size of 0.3 mm×1310 mm×1050 mm and coated with a photosensitive layer. The slip sheet 14 is a sheet made of bleached kraft pulp and having a basis weight of 30 to 45 g/m², a density of 0.7 to 0.85 g/m³, a moisture of 4 to 6%, a Bekk smoothness of 50 to 200 seconds, and a pH of 4 to 6.

The cardboards 16 which are made of used paper and having a basis weight of 400 to 1500 g/m², a density of 0.7 to 0.85 g/m³, a moisture of 4 to 8%, a Bekk smoothness of 3 to 20 seconds, and a pH of 4 to 6 are placed on the top and bottom surfaces of the stack of planographic printing plates 34.

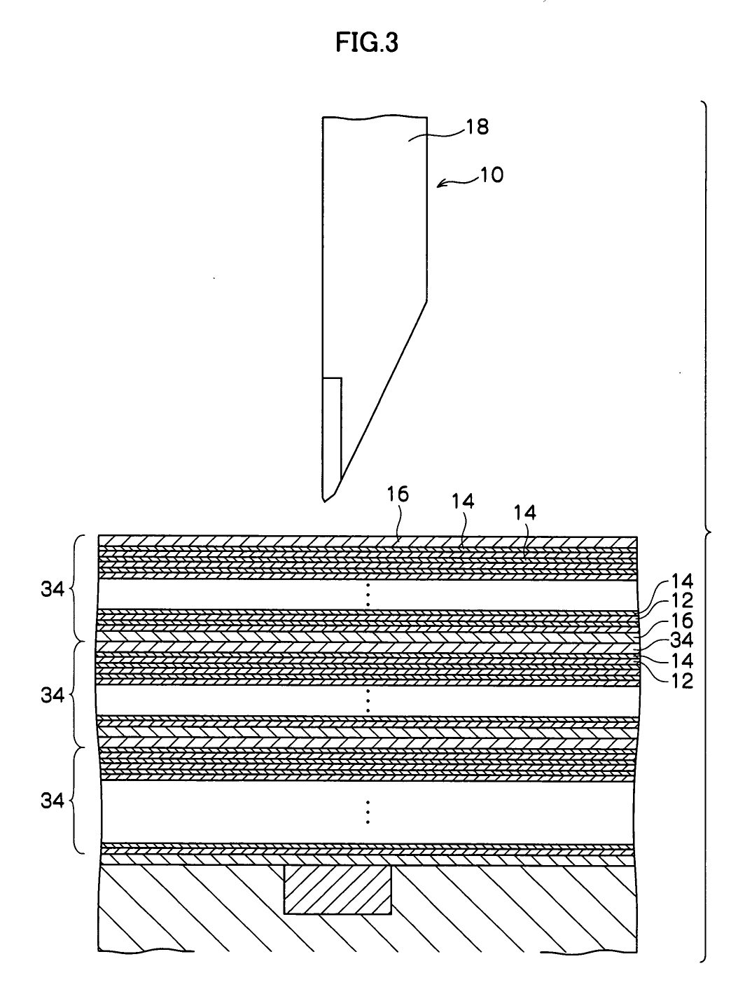

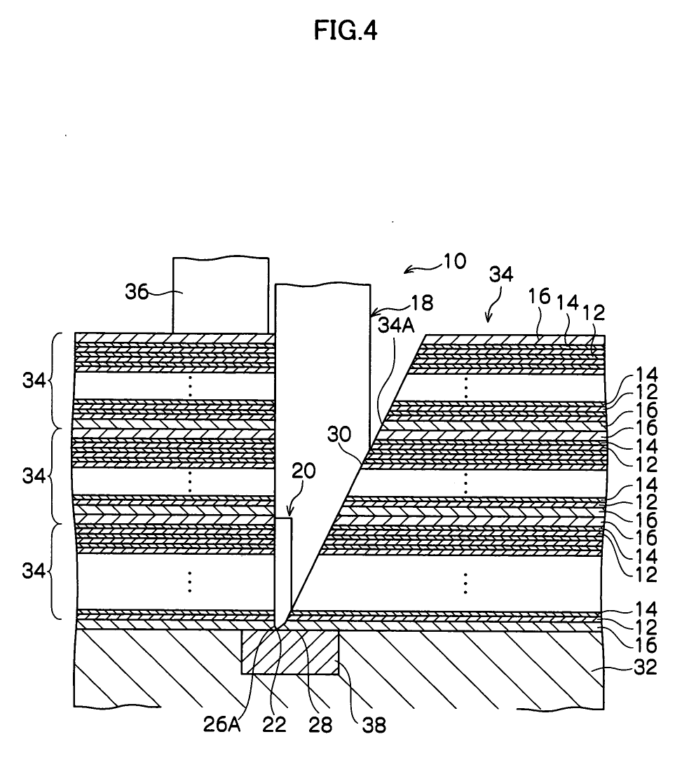

When the stacks of planographic printing plates 34 are cut, the edge 22 is pressed into the stacks of planographic printing plates 34 until the edge 22 hits a backing body 38 (made of polypropylene or nylon (trade name)).Thus, as shown in FIG. 3 and FIG. 4, the stacks of planographic printing plates 34 are cut by the first edge surface 28. At the same time, a cut surface 34A of the stacks of planographic printing plates 34 that is on the side not secured by the clamp 36 is pressed and inclined by the second edge surface 30. If the quality of the cut surface 34A is poor (for example, a large burr or warp is formed, or paper powder sticks on a printing surface of the planographic printing plate 12), the edge portion opposite to the cut surface 34A of the stacks of planographic printing plates 34 that is not formerly secured by the clamp 36 is aligned; and the stacks of planographic printing plates 34 not formerly secured is pressed by the clamp 36 and is set so that the cut surface 34A is cut off in a cutting thickness of 0.5 mm or more and then is again cut for finishing. Thus, for the stacks of planographic printing plates 34 that are on the side not secured by the clamp 36, quality of the cut surface is assured.

Since the edge 22 of the cutting blade 10 of the embodiment 1 is made of a high-speed steel powder sintered body, the edge 22 is excellent not only in hardness but also toughness. Accordingly, even after cutting a large number of planographic printing plates 12, reduction in sharpness of the edge 22 is minimal.

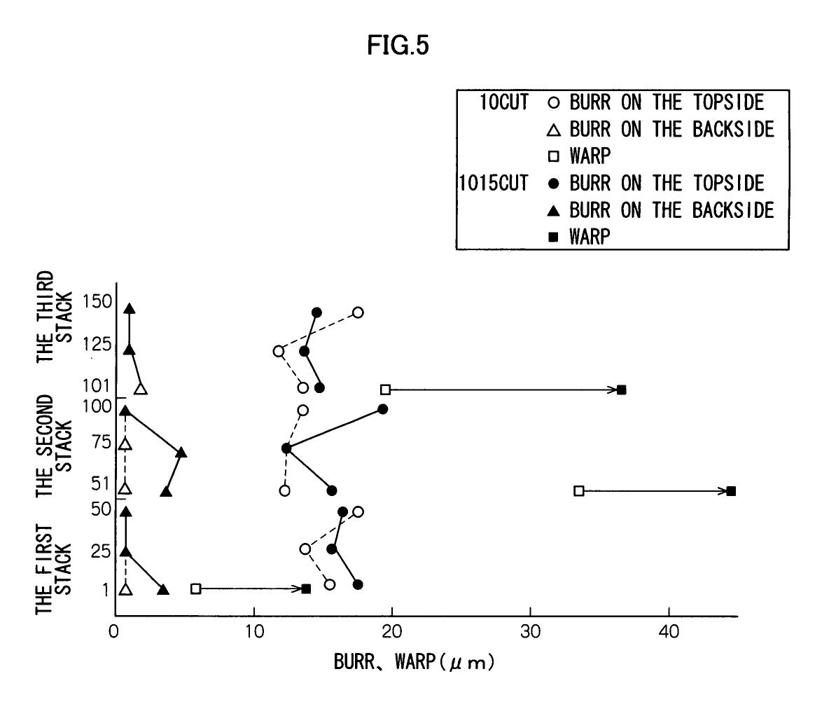

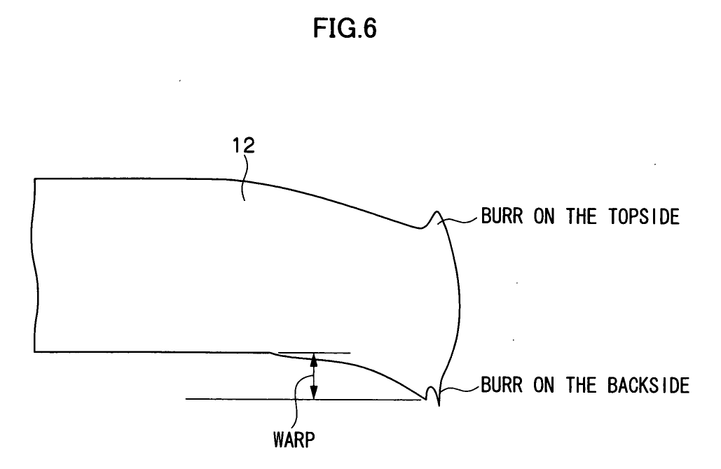

Results obtained by cutting three stacks of planographic printing plates 34, each stack of which includes 50 layered planographic printing plates 12 by the cutting blade 10, are shown in FIG. 5. Here, as shown in FIG. 6, a topside burr and a backside burr are burrs formed on the topside and backside of the planographic printing plate 12, respectively. The topside surface and the backside surface of the planographic printing plate 12 are the surface having a plate making layer formed thereon and the surface opposite thereto, respectively. Warp is an amount of a curve formed in a direction of cutting when the planographic printing plate 12 is cut by the cutting blade 10.

As shown in FIG. 5, all of the topside burr, the backside burr, and the warp are within standards even in the 10th cutting and in the 1015th cutting.

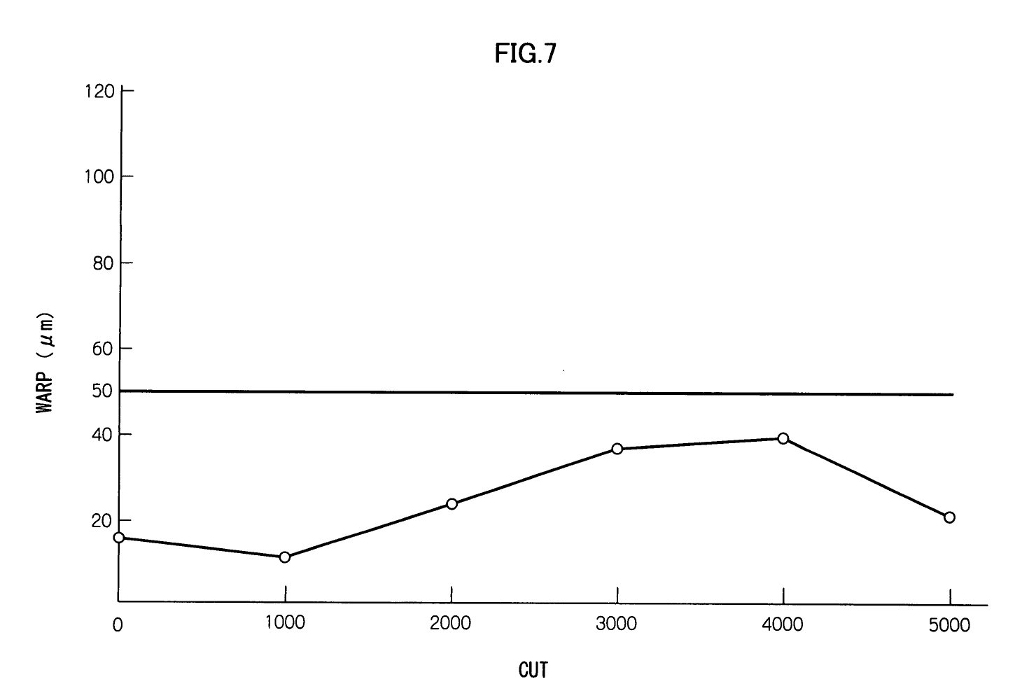

As shown in FIG. 7, the magnitude of warp is smaller than a standard value of 50 μm even in the 1000th cutting, 2000th cutting, 3000th cutting, 4000th cutting, and 5000th cutting.

Accordingly, even after cutting a large number of planographic printing plates by the above-mentioned cutting blade, a large warp is not formed on the cut surface.

A high-speed steel powder used for the above-mentioned cutting blade is usually a fine rapidly-solidified powder manufactured by a gas atomizing method. The high-speed steel powder sintered body is formed by pressing the high-speed steel powder by a hot isostatic press at a high temperature and under a high pressure. Accordingly, the high-speed steel powder sintered body does not have pores and has a non-segregated fine metal structure. Therefore, in the high-speed steel powder sintered body, fine carbide particles are dispersed uniformly, and thus, the high-speed steel powder sintered body has a high workability and shows a minimal strain when heat treated and is excellent in toughness, resistance to fatigue and wear. Consequently, the high-speed steel powder sintered body is not only harder but also more resistant to wear than a rolled-powder die steel sintered body. In the above-mentioned cutting blade, at least its edge is formed of the high-speed steel powder sintered body. Hence, even after cutting a large number of planographic printing plates by the above-mentioned cutting blade, nicking of the edge of the cutting blade and formation of a built-up edge by aluminum adhesion to the edge thereof can be effectively prevented.

In the above-mentioned cutting blade, the edge portion is a portion of the cutting blade where an edge is formed.

A second aspect of the present invention relates to a cutting blade of the first aspect wherein the above-mentioned high-speed steel powder sintered body contains 8.5 weight % or less of cobalt.

In the cutting blade, the high-speed steel powder sintered body contains 8.5 weight % or less of cobalt. Accordingly, formation of a built-up edge by aluminum adhering to the edge of the cutting blade when cutting stacks of planographic printing plates and generation of a large warp at the cutting surface of the planographic printing plate can be effectively prevented.

A third aspect of the present invention relates to the cutting blade of the first or the second aspect further comprising a first edge surface being formed on a side opposite to the backside surface and leading from the edge and inclining at a first angle with respect to a reference plane for sharpening, and a second edge surface leading to the end of the first edge surface and inclining at a second angle smaller than the first angle in the direction of press-cutting, at least an edge portion forming the first edge surface being formed of the high-speed steel powder sintered body.

In the above-mentioned cutting blade, when sheets are cut by the first edge surface, the second edge surface following the first edge surface pushes the sheets outside, and thus, a load applied to the first edge surface is reduced. Accordingly, the life of the cutting blade can be extended and the edge surface is not prone to be stuck by aluminum.

The reference plane for sharpening is defined as a tangent surface of the cutting blade of which backside surface is placed on a grinding bench in a state where the edge is protruded approximately 5 to 20 mm from the grinding bench.

A fourth aspect of the present invention relates to the cutting blade of the third aspect wherein a backside edge surface inclining in a direction opposite to the first edge surface and leading to the first edge surface is formed on the edge portion.

The edge of a freshly sharpened conventional cutting blade is so sharp that the edge is easily nicked, and only after cutting a certain number of stacks of sheets by the cutting blade and the edge thereof is worn, does a stable cutting surface form on the cutting blade. On the contrary, since the cutting blade of the present invention has the backside edge surface formed on the edge portion, the cutting blade is not prone to be nicked even when freshly sharpened and thus, the cutting blade can be used in a stable state and does not generate burrs at the corners of the cut surfaces of the sheets.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cutting blade for press-cutting a stack of layered sheets comprising an edge portion formed of a high-speed steel powder sintered body.

2. The cutting blade of claim 1, wherein the high-speed steel powder sintered body contains 8.5 weight % or less of cobalt.

3. The cutting blade of claim 1, further comprising a first edge surface being formed on a side opposite to a backside surface and leading from an edge and inclining at a first angle with respect to a reference plane for sharpening, and a second edge surface leading to an end of the first edge surface and inclining at a second angle smaller than the first angle in a direction of press-cutting, at least an edge portion forming the first edge surface being formed of the high-speed steel powder sintered body.

4. The cutting blade of claim 2, further comprising a first edge surface being formed on a side opposite to a backside surface and leading from an edge and inclining at a first angle with respect to a reference plane for sharpening, and a second edge surface leading to an end of the first edge surface and inclining at a second angle smaller than the first angle in a direction of press-cutting, at least an edge portion forming the first edge surface being formed of the high-speed steel powder sintered body.

5. The cutting blade of claim 3, wherein a surface leading to the first edge surface and inclining in a direction opposite to the first edge surface is formed on a surface opposite to the first edge surface of the edge portion.

6. The cutting blade of claim 4, wherein a surface leading to the first edge surface and inclining in a direction opposite to the first edge surface is formed on a surface opposite to the first edge surface of the edge portion.
